(19) United States
(12) Patent Application Publication
(10) Pub. No.: US 2026/0098930 A1
(43) Pub. Date: Apr. 9, 2026

(54) Method and Device for Detecting Positions Between Traffic Participants

(71) Applicant: Robert Bosch GmbH, Stuttgart (DE)

(72) Inventors: Alessandro Moia, Holzgerlingen (DE); Peter Matt, Salmendingen (DE); Andreas Wienss, Eningen Unter Achalm (DE)

(21) Appl. No.: 19/113,329

(22) PCT Filed: Sep. 20, 2023
(86) PCT No.: PCT/EP2023/075879

§ 371 Date: Mar. 19, 2025

(30) Foreign Application Priority Data
Sep. 26, 2022 (DE) 10 2022 210 111.1

(51) Int. Cl. G01S 5/02

(52) U.S. Cl. CPC G01S 5/0289; G01S 5/0294

(57) ABSTRACT

A method detects the relative positions of at least a first road user with a first transmitter and receiver unit and a second road user with a second transmitter and receiver unit, in a spatially defined area. The transmitter and receiver units are radio-based and no absolute positioning is carried out. Furthermore, the method includes radio-based measurement of a distance by the first road user via the transmitter and receiver units between the first road user and the second road user at a defined time in the defined area and generation of distance information. The method further includes providing the distance information to the second road user via the radio-based transmitter and receiver unit.

### PRIOR ART

The present invention relates to a method and a device for detecting relative positions between road users.

In road traffic, communication technologies can now be used to exchange the absolute positions, speeds and directions of vehicles. With additional information such as map data, acceleration, steering angle, rate of turn, etc., the vehicles can predict and warn of accidents or carry out automatic braking actions. According to the prior art, the exact absolute positions of the vehicles are required for this application. On the one hand, this is expensive and, on the other, there are many problems that can occur when receiving signals from navigation satellites, such as shadowing, reflections or atmospheric influences. This means that a sufficiently accurate absolute position of the vehicle is not available in all cases, which has a negative impact on the quality of the collision prediction.

It would be desirable to have a method that uses radio-based transmitter and receiver units to ascertain information about the position and movement status of road users without the need for absolute positioning. The method should be both fast and cost-effective and at the same time provide information with a high degree of accuracy.

### DISCLOSURE OF THE INVENTION

The method according to the invention for detecting relative positions between at least a first road user with a first transmitting and receiving unit and a second road user with a second transmitting and receiving unit, in a spatially defined area according to claim 1, and the device according to the invention according to claim 15 solve this task.

The method according to the invention of independent claim 1 comprises the steps of measuring a distance by means of the transmitter and receiver units between the first road user and a second road user in a defined area at a defined time and generating distance information. A further step consists of providing the measured distance information by means of the radio-based transmitter and receiver units, such that at least one road user can access the position information recorded by the other road user.

The method does not require absolute positioning. Absolute positioning is primarily understood to mean determining a position with the aid of the global navigation satellite system. Absolute speeds can be recorded as part of the method.

The spatially defined area in which the method for detecting relative position between road users is carried out is defined in such a way that it includes the nearest road users around the first road user. However, the method preferably comprises at least four road users in order to be geographically defined. In areas with high traffic density, the area in which the method is carried out can be reduced. The maximum area is limited by the range of the radio-based transmitter and receiver units.

At least one piece of distance information is ascertained between the first and a second road user. The distance information only needs to be ascertained once and can be ascertained by both the first and second road user.

In addition to detecting positions between the first road user and the second road user, detecting positions between the first and a third or the first and a fourth road user is also possible.

Preferably, the distance information should be ascertained between all road users in the spatially defined area. With four or more road users, individual distance information becomes redundant and can be derived trigonometrically.

Once the distance information has been ascertained, it is made available to other road users. Road users should preferably have access to all distance information between road users in the area spatially defined around the respective road user. Preferably, however, the first road user has access to all distance information in the area spatially defined around it. The distance information can be actively sent to all or individual other road users in the spatially defined area on a permanent basis, or it can be sent to one or more other road users only on request.

The distance information can be ascertained via radio using time-of-flight and/or phase measurement. Possible radio standards for ascertaining and transmitting distance information include Ultra wideband, Bluetooth from revision Denver, C-V2X sidelink positioning from 3GPP Rel. 18, IEEE 802.11bd or successor technologies.

Distance measurement and data transmission can take place via the same transmission path or the same radio technology or via different transmission paths or different radio technologies. Different transmission paths create redundancies and increase availability if one of the transmission paths fails. A simple transmission path reduces the costs of the transmitter and receiver unit.

By ascertaining the distance between road users, it is possible to obtain the position information of road users easily and reliably with a low latency time.

The dependent claims show preferred further modifications of the invention.

According to a preferred further modification, the first road user determines the speed of the second road user by radio. Two pieces of distance information at two discrete measurement times between two road users can be used to determine their relative speed to each other. The absolute speed of road users can also be ascertained wirelessly by knowing the position of other road users. A radio speed information is generated from the speed ascertained by radio between two road users and made available to the other road users. The same radio speed information is preferably not ascertained several times by different road users. This makes it quick and easy to ascertain additional information about road users in the vicinity.

The ascertained radio speed information between the two discrete measurement times are averaged speeds. To ensure that the averaged speed matches the actual speed at the second measurement time as closely as possible, the time span between the first and second measurement times should be as short as possible.

If, for example, the distances between the first and second road user do not change over time, it can be concluded that both road users are traveling at the same absolute speed. The relative speed between road users is 0 km/h.

Further preferably, at least the first and/or the second road user determines an absolute speed via a speed sensor and provides this as sensor speed information and/or a direction via a direction sensor and provides this direction to other road users as direction information. The absolute speed can be ascertained using a wheel or engine speed sensor, for example. The direction information can be ascertained using a steering angle sensor, an acceleration sensor or a digital compass, for example. Determining an absolute speed makes it possible to ascertain the absolute speed of other road users based on their relative speeds. Thus, by determining the sensor speed information and/or the direction information using simple sensors, further information about the driver's own position and the position of other road users can be ascertained quickly.

For example, if the distances between the first and second road user do not change over time and the first road user is traveling at a measured absolute speed of 25 km/h, it can be concluded that the second road user is also traveling at an absolute speed of 25 km/h.

Preferably, the distance information and/or the radio speed information and/or the sensor speed information and/or the direction information is transmitted between the road users by means of direct communication and not, for example, via external servers. This further improves the latency of data acquisition and position detection.

It is also preferred to carry out relative positioning of the road users on the basis of the distance information and the sensor speed information and/or the radio speed information and/or the direction information. Based on the recorded position data, the road users are placed at a starting position in a coordinate system. The coordinate system is preferably a Cartesian coordinate system. The first road user is placed at the origin of the coordinates. The second road user is placed on a positive coordinate axis according to the previously determined distance information from the first road user. A preferably third road user is placed in the positive coordinate space by the first road user according to the previously determined distance information and by the second road user according to the further previously determined distance information. Other road users can be freely positioned in the space according to the distance information ascertained in each case. Due to the specifications for the positioning of the first three road users, there is only one mapping solution. Without the specification, an infinite number of solutions for the relative positioning of road users would be possible by shifting, rotating or mirroring. The first road user is preferably the road user for whom the method according to the invention is carried out. The other road users can, for example, be numbered according to their distance from the first road user.

Distance information between three road users can also be calculated using exactly one piece of direction information and two pieces of distance information between three road users, or two pieces of distance information can be calculated if two pieces of direction information and exactly one piece of distance information between the road users are known. After the initial positioning, further positions of the road users can be ascertained at a second point in time using newly ascertained distance information between the road users, as well as their radio speed information and/or sensor speed information and/or direction information between the time of the initial position and the second point in time. In this way, an image of the road users in the spatially defined area can be created wirelessly and without the aid of absolute positions.

In another preferred embodiment, the relative position of the road users is displayed on a virtual map. The display on the virtual map allows a quick visual perception and assessment of the surrounding road users.

In a preferred embodiment, the direction information of the direction of movement of the at least first and/or second road user is determined on the basis of the ascertained distance information and the radio speed information and/or sensor speed information. To do this, the relative positions of the road users must be known. Distance information from preferably four road users is known at two discrete points in time. This means that direction information can be ascertained simply, accurately and quickly by radio, without the aid of absolute position information.

In a further advantageous further modification of the method, the radio speed information of the second road user ascertained by the first road user is compared with the sensor speed information of the second road user and a speed plausibility check is carried out. The speed plausibility check can also be carried out for any number of other road users. The sensor speed information or the radio speed information can be validated using the speed plausibility check. Furthermore, any deviations in the radio speed information can be corrected.

Similarly, redundant measured values can be used to detect errors in the transmission and processing chain, resulting in a more robust method.

Speed plausibility checks are also preferred for tuning detection. The tuning detection method is preferably used for electric bikes. A tuning can be ascertained by comparing the speed of the second road user measured by the first road user and the own sensor speed information provided by the second road user. For example, the first road user is traveling at a speed of 25 km/h and is quickly overtaken by the second road user, wherein the absolute speed of the second road user ascertained by radio results in 40 km/h. If the second road user now indicates a speed of 25 km/h, it can be recognized that the speed sensor of the second road user has been tampered with. Tuned road users, such as electric bicycles, pose a considerable danger to other road users. The external tuning control enables effective and tamper-proof tuning protection.

In a further preferred embodiment, the distance information and the direction information or additionally the sensor speed information and/or radio speed information are used to perform a collision prediction between the road users. Additional information, such as weather data, can also be included. Preferably, the collision prediction is carried out by the first road user and determines the risk of a collision between the second road user or other road users and the first road user. However, it is also possible, for example, for the first road user to predict a collision between the second and third road user and warn them in the event of a hazard. Similarly, the second road user can, for example, carry out the collision prediction for the first road user and warn them in the event of danger. This enables simple, accurate and fast collision prediction without the need for absolute positioning. For example, if the distance between the first and second road user is constantly reduced over time, there is a risk of collision.

In a further possible embodiment, at least the first and/or second road user comprises several transmitter and receiver units for determining the relative distance between the road users. Each transmitter and receiver unit can serve as a theoretical road user. This artificial increase in the number of road users through additional transmitter and receiver units on the road users allows, among other things, more accurate relative positioning and collision prediction with a small number of actual road users. The fixed distance between several radio-based transmitter and receiver units on the road user can also be used to validate and calibrate the measured values.

Preferably, a transmitter and receiver unit is arranged at a front and a rear area of the road user and/or at a left and a right area of the road user. In addition to more precise relative positioning, this makes it possible to make statements about the orientation of the road user.

Further preferred road users can include stationary objects with transmitter and receiver units. Possible stationary objects are preferably traffic infrastructure objects, such as a traffic light, a lamppost or an intelligent paving stone. By definition, stationary objects have zero speed and therefore do not move away from their starting position. Equipping stationary objects with transmitter and receiver units to implement the inventive method increases the density of road users and improves relative positioning and collision prediction with a small number of nonstationary road users. Due to the defined speed of the stationary objects with transmitter and receiver units, they can also be used for calibration purposes.

Nonstationary road users include cars, bicycles, motorcycles and trucks, which have transmitter and receiver units for position detection.

In a further preferred embodiment, at least the second road user ascertains at least the distance information and/or the radio speed information and/or the direction information of a third road user via its radio-based transmitter and receiver unit and makes this available to at least the first road user. This enables the first road user, for example, to obtain information between the second and third road user which the first road user cannot measure directly. The method can be applied to any other road user.

The invention also relates to a device adapted to carry out the inventive method. Preferably, the device comprises a computing unit and a memory in which the method according to the invention is carried out. Furthermore, the device calculates the collision prediction from the relative positions and speeds of the road users and/or carries out the tuning detection. The device for carrying out the inventive method is preferably part of at least the first road user.

### BRIEF DESCRIPTION OF THE DRAWING

In the following, exemplary embodiments of the invention are described in detail with reference to the accompanying drawing. In the drawing is:

FIG. 1 a schematic representation of a method according to the invention for ascertaining the distance between road users according to an exemplary embodiment of the invention.

### EMBODIMENT OF THE INVENTION

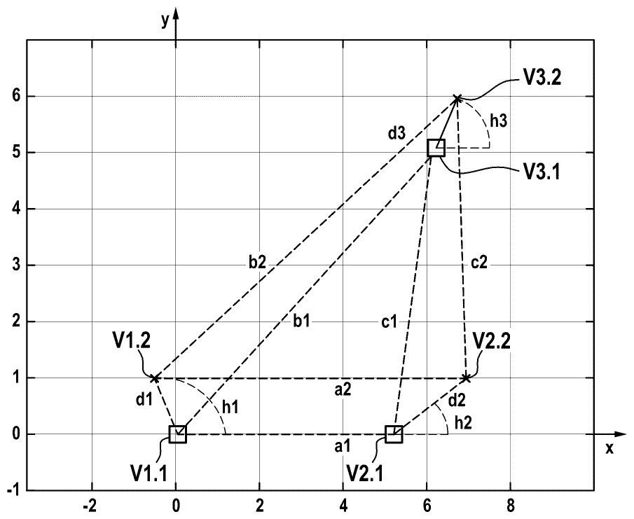

With reference to FIG. 1, a method for exclusively radio-based detecting of relative positions between road users according to an exemplary embodiment of the invention is described in detail below.

FIG. 1 schematically shows relative positions of road users V1, V2, V3 at time t1 in the form of three points V1.1, V2.1 and V3.1 in a Cartesian coordinate system, which represent the initial relative position of three road users as an example. Between the points V1.1, V2.1 and V3.1, the distances a1, b1 and c1 are drawn between the points. For the sake of clarity, the method according to the invention is illustrated in FIG. 1 in two dimensions using three road users.

Preferably, the method comprises more than three road users and can be applied analogously to a large number of road users in two or three dimensions.

The distances a1, b1 and c1 are measured via radio-based methods between the road users V1.1, V2.1 and V3.1 at a defined time t1. Road user V1.1, for example, can only directly measure the distances a1 and b1 from road users V2.1 and V3.1 to itself. The distance c1 can only be measured directly by V2.1 and V3.1. The road users then form distance information from the measured distances and make this available to other road users in the spatially defined area. It is therefore possible, for example, for road user V1.1 to request the distance c1 between road users V2.1 and V3.1 from one of these road users.

From a certain number of road users and distance information, further distance information can be calculated trigonometrically from the previously recorded distance information. Distance information is preferably only measured once between road users at a defined point in time.

With a double measurement, redundant information can be used to detect errors in the transmission and processing chain.

Since only the relative distances a1, b1 and c1 between the road users V1.1, V2.1 and V3.1 are known for the initial relative positioning, the points could be moved, mirrored or rotated in space as required without changing the distances to each other. In order to nevertheless determine a defined initial relative position, the first road user V1.1 is placed in the coordinate origin to prevent the points from shifting. The second road user V2.1 is placed at a distance al on the x-axis to prevent the points from rotating. The third road user V3.1 is placed at a distance bl from V1.1 and at a distance c1 from V2.1 in the positive coordinate space to prevent the points from being mirrored.

The distances b1 and c1 do not have to be specified explicitly, but can also be calculated on the basis of direction information or knowledge of an angle between b1 and a1 and/or c1 and a1.

The movement of road users changes their relative position. The second relative position of road users V1.2, V2.2 and V3.2 at a time t2 can be calculated trigonometrically using the distances d1, d2 and d3 they have traveled and the associated directions h1, h2 and h3. The data ascertained from the individual road users is exchanged directly with each other.

The distances d1, d2 and d3 can be determined from the mean speed of the road users from time t1 of the last relative positioning to time t2. Alternatively, the distances are measured directly. It is preferably assumed that the distance is covered in a straight line. For longer time intervals, the distance along a mean direction can be calculated taking into account the changes in direction between time t1 and time t2.

The directions h1, h2 and h3 can be determined directly by road users using sensors, such as steering sensors. Alternatively, the direction can be calculated using the last relative positions V1.1, V2.1 and V3.1, the distances a2, b2 and c2 between the road users at time t2 and the distances d1, d2 and d3. For a clear calculation of the directions from the distances between road users, the method should preferably include four or more road users.

A collision prediction can be made based on the relative position of the road users, their speed and/or direction. If, for example, road user V2 is approaching road user V1 at high speed and V1 is at a short distance from V2 or if the projected paths of the road users cross, there is a high probability of collision. The probability of collision is low at large distances from each other, low speeds and in opposite directions.

Based on the collision prediction, further actions can be taken, such as a warning tone for the road users concerned and/or an autonomous intervention in the direction of travel of the road users concerned and/or their braking or acceleration.

From the relative positions V1.2, V2.2 and V3.2, a new relative position can be ascertained again after a defined time, knowing the distance and direction of the road users, and a collision prediction between the road users can be carried out. The following listing of claims replaces all prior versions, and listings, of claims in the application:

1. A method for detecting relative positions of at least a first road user with a first transmitter and receiver unit and a second road user with a second transmitter and receiver unit, in a spatially defined area, the first and second transmitter and receiver units being radio-based, and , the method comprising
radio-based measurement of a distance by the first road user via the first and second transmitter and receiver units between the first road user and the second road user at a defined time in the spatially defined area and generating distance information; and
providing the distance information to the second road user via the second transmitter and receiver unit.
wherein no absolute positioning is performed.

2. The method according to claim 1, wherein at least the first road user measures a speed of the second road user by radio and generates radio speed information.

3. The method according to claim 2, wherein at least one of the first and second road users:
measures its absolute speed via a speed sensor and provides it the absolute speed as sensor speed information; and/or
determines a direction of a movement via a direction sensor and generates and provides direction information.

4. The method according to claim 3, wherein the distance information and/or the radio speed information and/or the sensor speed information and/or the direction information is exchanged directly between the first and second road users.

5. The method according to claim 3, wherein a relative positioning of the first and second road users with respect to each other is carried out based on the distance information and/or the radio speed information and/or the sensor speed information and/or the direction information.

6. The method according to claim 5, further comprising displaying the relative positioning of the first and second road users is on a virtual map.

7. The method according to claim 5, wherein a piece of direction information of the at least one of the first and second road users is determined based on the distance information and the radio speed information and/or the sensor speed information of the first and/or the second road user.

8. The method according to claim 3, wherein the first road user compares the radio speed information of the second road user with the absolute sensor speed information of the second road user and performs a speed plausibility check.

9. The method according to claim 8, wherein the speed plausibility check is used for tuning detection.

10. The method according to claim 3, wherein a collision prediction is carried out between two road users based on the distance information and the direction information or additionally the radio speed information and/or the sensor speed information.

11. The method according to claim 1, wherein at least one of the first and second road users comprises a at least one additional transmitting and receiving unit.

12. The method according to claim 11, wherein the at least one of the first and second road users comprises a transmitting and receiving unit is arranged at a front and a rear area of the road user and/or is arranged at a left and a right area of the at least one of the first and second road users.

13. The method according to claim 1, which is carried out with a plurality of road users, wherein one road user of the plurality of road users is stationary.

14. The method according to claim 3, wherein the second road user ascertains at least the distance information and/or the radio speed information and/or the direction information of a third road user via the second transmitter and receiver unit and makes it available to at least the first road user.

15. A device configured to execute the method according to claim 1.
